(19) United States
(12) Patent Application Publication
(10) Pub. No.: US 2011/0046950 A1
(43) Pub. Date: Feb. 24, 2011

(54) Wireless Dictaphone Features and Interface

(76) Inventors: Priyamvada Sinvhal-Sharma, Austin, TX (US); Sanjay Sharma, Austin, TX (US)

Correspondence Address: LEE & HAYES, PLLC, 601 W. RIVERSIDE AVENUE, SUITE 1400, SPOKANE, WA, 99201, US

(21) Appl. No.: 12/858,894

(22) Filed: Aug. 18, 2010

Related U.S. Application Data
(60) Provisional application No. 61/234,928, filed on Aug. 18, 2009.

(51) Int. Cl. G10L 15/26

(52) U.S. Cl. 704/235; 704/E15.043

(57) ABSTRACT

A system and method for a method for integrating a communications system with a dictation system on a mobile device includes displaying a first graphical user interface screen on a display of the mobile device, the first graphical user interface screen including a first plurality of selections, when selected by a user, enable the user to dictate and create one or more voice files for sending to a receiving server; and automatically displaying a second graphical user interface screen on the display of the mobile device when the communications system receives an incoming call, said second graphical user interface screen indicating suspension of dictation functionality and enabling telephone functionality.

### CROSS-REFERENCE TO RELATED APPLICATIONS

The present application is related to and claims the benefit of the earliest available effective filing date(s) from the following application(s) (the “Related Applications”) (e.g., claims earliest available priority dates for other than provisional patent applications or claims benefits under 35 USC §119(e) for provisional patent applications, for any and all parent, grandparent, great-grandparent, etc. applications of the Related Application(s)). The present application claims priority from U.S. Provisional Patent Application No. 61/234,928, entitled Wireless Dictaphone Features and Interface, naming Priyamvada Sinvhal-Sharma, and Sanjay Sharma as inventors, filed Aug. 18, 2009.

### TECHNICAL FIELD

The present application relates generally to dictation and transcription graphical user interface display systems and methods.

### SUMMARY

In one aspect, a method for integrating a communications system with a dictation system on a mobile device includes displaying a first graphical user interface screen on a display of the mobile device, the first graphical user interface screen including a first plurality of selections, when selected by a user, enable the user to dictate and create one or more voice files for sending to a receiving server; and automatically displaying a second graphical user interface screen on the display of the mobile device when the communications system receives an incoming call, said second graphical user interface screen indicating suspension of dictation functionality and enabling telephone functionality. In addition to the foregoing, other method aspects are described in the claims, drawings, and text forming a part of the present application.

In another aspect, a computer readable medium is provided with stored thereon sequences of instructions which are executable by a processor, and which, when executed by the processor, cause the processor to perform the steps of: displaying a first graphical user interface screen on a display of the mobile device, the first graphical user interface screen including a first plurality of selections, when selected by a user, enable the user to dictate and create one or more voice files for sending to a receiving server; and automatically displaying a second graphical user interface screen on the display of the mobile device when the communications system receives an incoming call, said second graphical user interface screen indicating suspension of dictation functionality and enabling telephone functionality.

In addition to the foregoing, other computer program product aspects are described in the claims, drawings, and text forming a part of the present application.

In one or more various aspects, related systems include but are not limited to circuitry and/or programming for effecting the herein-referenced method aspects; the circuitry and/or programming can be virtually any combination of hardware, software, and/or firmware configured to effect the herein-referenced method aspects depending upon the design choices of the system designer. In addition to the foregoing, other system aspects are described in the claims, drawings, and text forming a part of the present application.

In one aspect, a network transcription system includes but is not limited to a network controller; a processor coupled to the network controller; a memory coupled to the processor; a receiver coupled to the processor; and a dictation module coupled to the memory, the dictation module configured to implement a first graphical user interface screen on a display of the mobile device, the first graphical user interface screen including a first plurality of selections, when selected by a user, enable the sender to dictate and create one or more voice files for sending to a receiving server; and automatically implement a second graphical user interface screen on the display of the mobile device when the communications system receives an incoming call, said second graphical user interface screen indicating suspension of dictation functionality and enabling telephone functionality.

In addition to the foregoing, various other method, system, and/or computer program product aspects are set forth and described in the text (e.g., claims and/or detailed description) and/or drawings of the present application.

The foregoing is a summary and thus contains, by necessity, simplifications, generalizations and omissions of detail; consequently, those skilled in the art will appreciate that the summary is illustrative only and is NOT intended to be in any way limiting. Other aspects, features, and advantages of the devices and/or processes and/or other subject described herein will become apparent in the text set forth herein.

### BRIEF DESCRIPTION OF THE DRAWINGS

A better understanding of the subject matter of the application can be obtained when the following detailed description of the disclosed embodiments is considered in conjunction with the following drawings, in which:

FIG. 1 is a block diagram of an exemplary computer architecture that supports the claimed subject matter of the present application;

FIG. 2 is a block diagram of a network environment that supports the claimed subject matter of the present application;

FIG. 3 is a block diagram of a communication device appropriate for embodiments of the subject matter of the present application;

FIG. 4 illustrates a flow diagram of a method in accordance with an embodiment of the subject matter of the present application;

FIG. 5 illustrates a graphical user interface for a dictation application illustrating a dictation page in accordance with an embodiment of the present application;

FIG. 6 illustrates a graphical user interface for a dictation application illustrating a Work List page in accordance with an embodiment of the present application;

FIG. 7 illustrates a graphical user interface for a dictation application illustrating a archived dictations page in accordance with an embodiment of the present application;

FIG. 8 illustrates a graphical user interface for a dictation application illustrating a recording information page in accordance with an embodiment of the present application;

FIG. 9 illustrates a graphical user interface for a dictation application illustrating a transcription page in accordance with an embodiment of the present application; and

FIG. 10 illustrates a graphical user interface for a dictation application illustrating a settings page in accordance with an embodiment of the present application.

### DETAILED DESCRIPTION OF THE DRAWINGS

In the description that follows, the subject matter of the application will be described with reference to acts and symbolic representations of operations that are performed by one or more computers, unless indicated otherwise. As such, it will be understood that such acts and operations, which are at times referred to as being computer-executed, include the manipulation by the processing unit of the computer of electrical signals representing data in a structured form. This manipulation transforms the data or maintains it at locations in the memory system of the computer which reconfigures or otherwise alters the operation of the computer in a manner well understood by those skilled in the art. The data structures where data is maintained are physical locations of the memory that have particular properties defined by the format of the data. However, although the subject matter of the application is being described in the foregoing context, it is not meant to be limiting as those of skill in the art will appreciate that some of the acts and operations described hereinafter can also be implemented in hardware, software, and/or firmware and/or some combination thereof

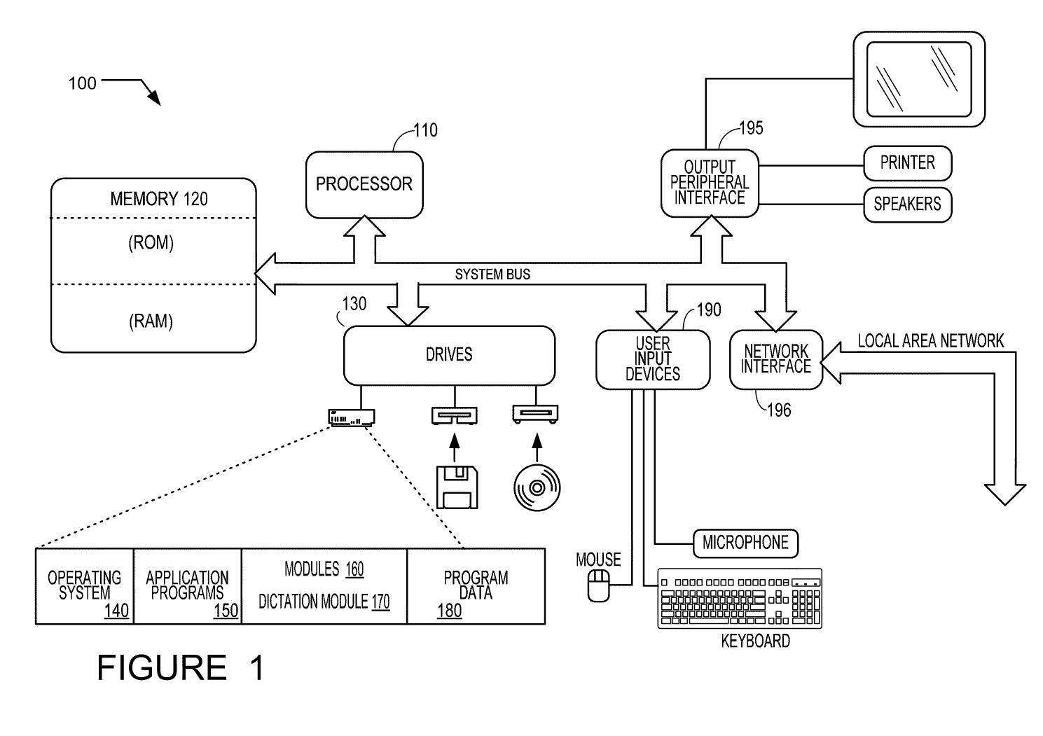

With reference to FIG. 1, depicted is an exemplary computing system for implementing embodiments. FIG. 1 includes a computer 100, which could be a communications-capable computer, including a processor 110, memory 120 and one or more drives 130. The drives 130 and their associated computer storage media, provide storage of computer readable instructions, data structures, program modules and other data for the computer 100. Drives 130 can include an operating system 140, application programs 150, program modules 160, such as dictation module 170 and program data 180. Computer 100 further includes user input devices 190 through which a user may enter commands and data. Input devices can include an electronic digitizer, a microphone, a keyboard and pointing device, commonly referred to as a mouse, trackball or touch pad. Other input devices may include a joystick, game pad, satellite dish, scanner, or the like. In one or more embodiments, user input devices 190.

These and other input devices can be connected to processor 110 through a user input interface that is coupled to a system bus, but may be connected by other interface and bus structures, such as a parallel port, game port or a universal serial bus (USB). Computers such as computer 100 may also include other peripheral output devices such as speakers, which may be connected through an output peripheral interface 195 or the like. More particularly, output devices can include communication-enabling devices capable of providing voice output in response to voice input.

Computer 100 may operate in a networked environment using logical connections to one or more remote computers, such as a remote computer. The remote computer may be a personal computer, a server, a router, a network PC, a peer device or other common network node, and can include many or all of the elements described above relative to computer 100. Networking environments are commonplace in offices, enterprise-wide computer networks, intranets and the Internet. For example, in the subject matter of the present application, computer 100 may comprise the source machine from which data, such as voice files can be migrated, and the remote computer may comprise the destination machine. Note however that source and destination machines need not be connected by a network or any other means, but instead, data may be migrated via any media capable of being written by the source platform and read by the destination platform or platforms. When used in a LAN or WLAN networking environment, computer 100 is connected to the LAN through a network interface 196 or adapter. When used in a WAN networking environment, computer 100 typically includes a modem or other means for establishing communications over the WAN, such as the Internet. It will be appreciated that other means of establishing a communications link between the computers may be used.

According to one embodiment, computer 100 is connected in a networking environment such that the processor 110 and/or dictation module 170 determine whether an incoming phone call should disable the dictation function. The incoming phone call can be from a communication device. The dictation module can be code stored in memory 120. For example, processor 110 can determine that there is an incoming call, determine that the dictation module is operating apply automatically save dictation data and enable the user to take an incoming call.

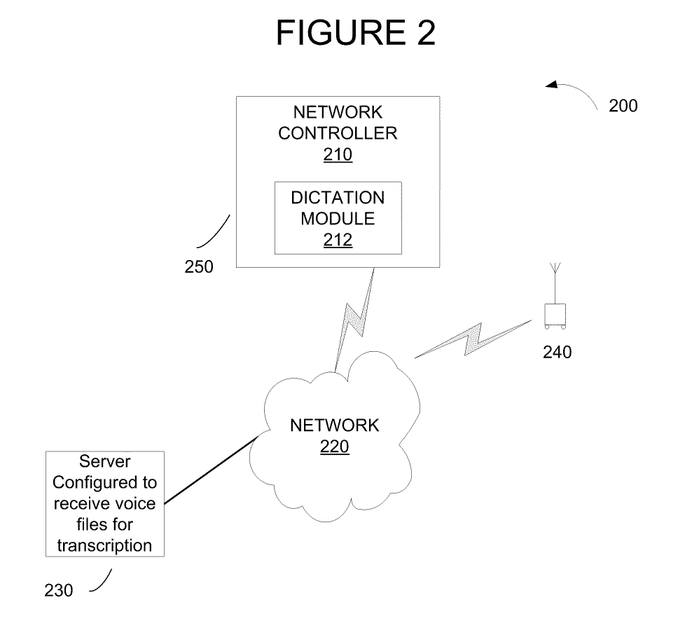

Referring now to FIG. 2, illustrated is an exemplary block diagram of a system 200 capable of being operable with dictation modules running on computer systems and interacting with a server configured to receive voice files created using dictation module 212. System 200 is shown including network controller 210, a network 220, and one or server 230. Communication device 250 may include telephones, wireless telephones, cellular telephones, personal digital assistants, computer terminals or any other devices that are capable of sending and receiving data.

Network controller 210 is connected to network 220. Network controller 210 may be located at a base station, a service center, or any other location on network 220. Network 220 may include any type of network that is capable of sending and receiving communication signals, including voice files created using dictation module 212. For example, network 220 may include a data network, such as the Internet, an intranet, a local area network (LAN), a wide area network (WAN), a cable network, and other like communication systems. Network 220 may also include a telecommunications network, such as a local telephone network, long distance telephone network, cellular telephone network, satellite communications network, cable television network and other like communications systems that interact with computer systems. Network 220 may include more than one network and may include a plurality of different types of networks. Thus, network 220 may include a plurality of data networks, a plurality of telecommunications networks, and a combination of data and telecommunications networks and other like communication systems.

In operation, communication device 250, may communication with a receiving communication device such as server 230. The communication can be routed through network 220 and network controller 210 to the receiving communication device. Simultaneously, communication device 250 may call or receive a call from communication device 240. In an embodiment, controller 210 is can include a dictation module 212 that can enable a connection during a dictation.

Controller 210 can alter the format of the display by determining that the second graphical user interface should be displayed to enable a user to determine whether or not to take a call or to continue dictation.

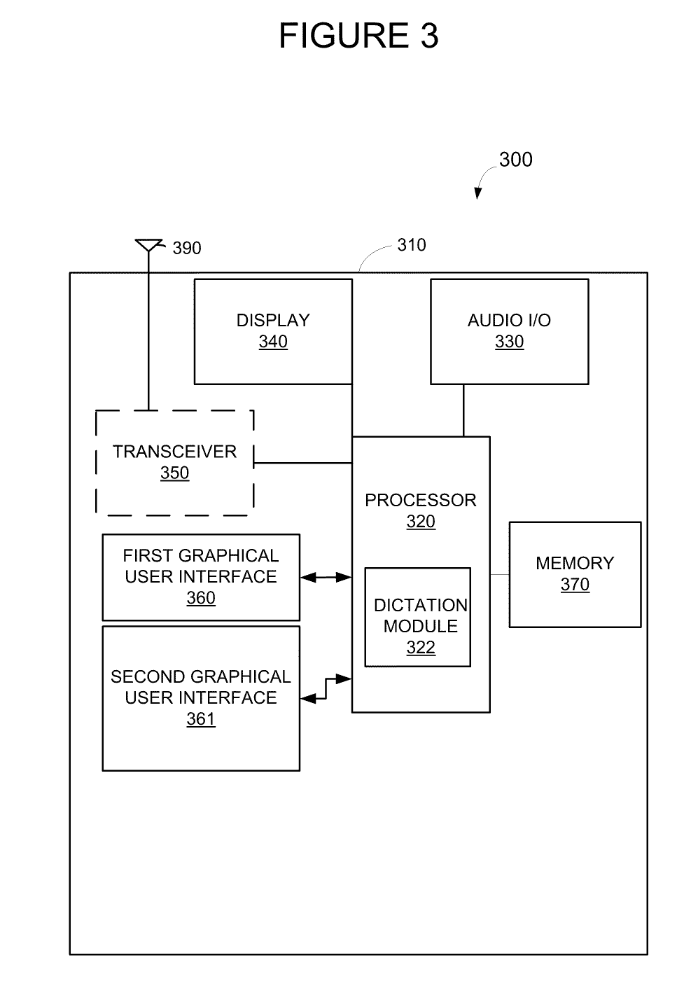

FIG. 3 is an exemplary block diagram of a communication device 300, such as communication devices 230 according to an embodiment. Communication device 300 can include a housing 310, a processor 320, audio input and output circuitry 330 coupled to processor 320, a display 340 coupled to processor 320, a first graphical user interface 360 and a second graphical user interface 361 coupled to processor 320 and a memory 370 coupled to processor 320. According to an embodiment, processor 320 includes dictation module 322. Dictation module 322 may be hardware coupled to the processor 320. Alternatively, dictation module 322 could be located within processor 320, or located in software located in memory 370 and executed by processor 320, or any other type of module. Memory 370 can include a random access memory, a read only memory, an optical memory, a subscriber identity module memory, or any other memory that can be coupled to a communication device. Display 340 can be a liquid crystal display (LCD), a light emitting diode (LED) display, a plasma display, or any other means for displaying information. Audio input and output circuitry 330 can include a microphone, a speaker, a transducer, or any other audio input and output circuitry. First graphical user interface 360 and second graphical user interface 361 can include an additional display, or any other device useful for providing an interface between a user and an electronic device. In one embodiment, the dictation module is a software application operable on an I-Phone® or an Android® mobile phone. Second graphical user interface 361 in one embodiment, can include a superimposed interface that provides caller identification, a query to the user allowing the call to be accepted, a phone number of a party calling the user, or a default user interface associated with the mobile device. The second graphical user interface can include a telephone interface that is incorporated into an IPhone® or an Android®phone.

Processor 320 can be configured to control the functions of communication device 300. Communication device 300 can send and receive signals across network 220 using a transceiver 350 coupled to antenna 390. Alternatively, communication device 300 can be a device relying on twisted pair technology and not require transceiver 350.

According to one embodiment, the processor 320 and/or dictation module 322 can determine whether an incoming call is occurring. The dictation module can be code stored in memory 370. For example, processor 320 can determine an incoming call is occurring and apply an appropriate second graphical user interface. Conversely, processor 320 and/or dictation module 322 can be responsive to a user indicating that an outgoing call is to be made and implement the second graphical user interface.

In one embodiment, the dictation module is configured to determine whether a processor (in either computer 100, communication device 300, or in a network controller) should implement a dictation mode or a telephone mode.

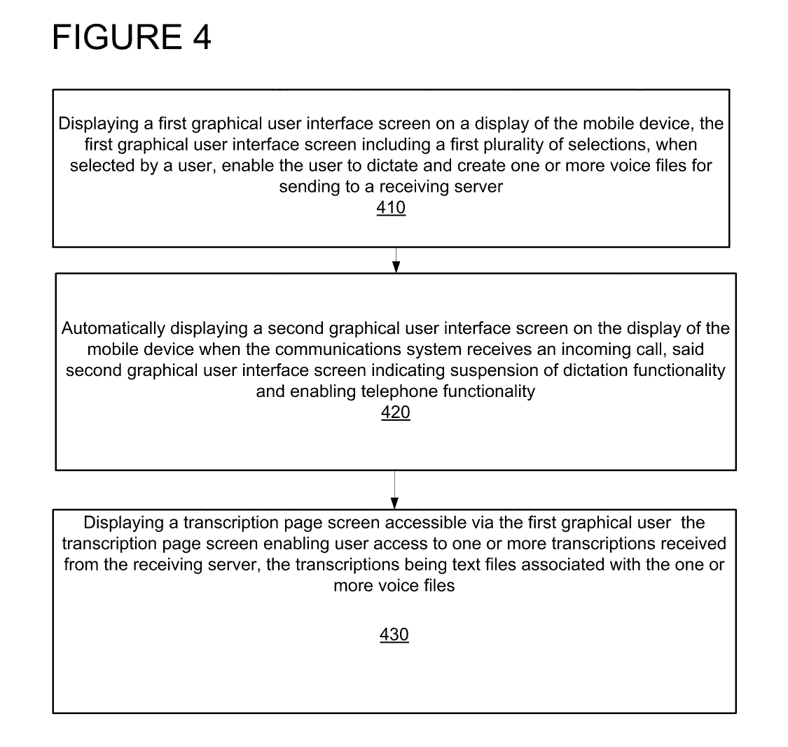

Referring now to FIGS. 4, an exemplary flow diagram illustrates the operation of the processor 320 and/or dictation module 322 and/or network controller 210 according to an embodiment. One of skill in the art with the benefit of the present disclosure will appreciate that act(s) can be taken by dictation module 322, network controller 210, processor 110, and/or dictation module 170.

Block 410 provides for displaying a first graphical user interface screen on a display of the mobile device, the first graphical user interface screen including a first plurality of selections, when selected by a user, enable the user to dictate and create one or more voice files for sending to a receiving server. For example, a mobile device can operate via a network capable of transmitting voice files from a user and have a computer, such as computer 100, or network controller 210, to provide transcriptions back to the user.

Block 420 provides for automatically displaying a second graphical user interface screen on the display of the mobile device when the communications system receives an incoming call, said second graphical user interface screen indicating suspension of dictation functionality and enabling telephone functionality. For example, the second graphical user interface screen can be a default IPhone® telephone interface.

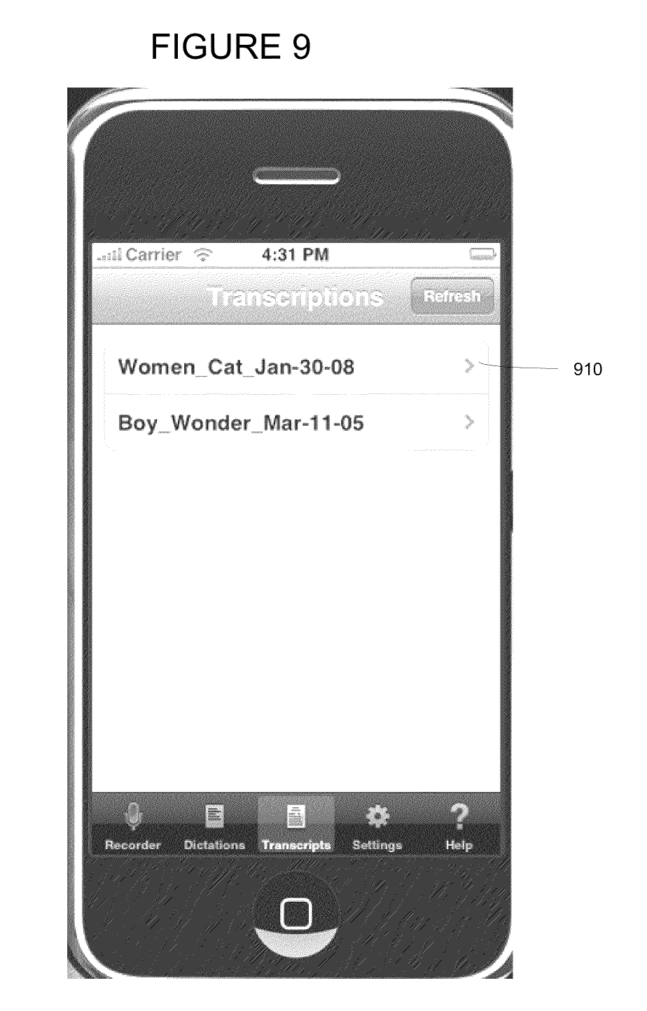

Block 430 provides for displaying a transcription page screen accessible via the first graphical user the transcription page screen enabling user access to one or more transcriptions received from the receiving server, the transcriptions being text files associated with the one or more voice files. For example, as shown in FIG. 9 illustrates a transcription page that illustrates text files received from a remote server providing a transcription service.

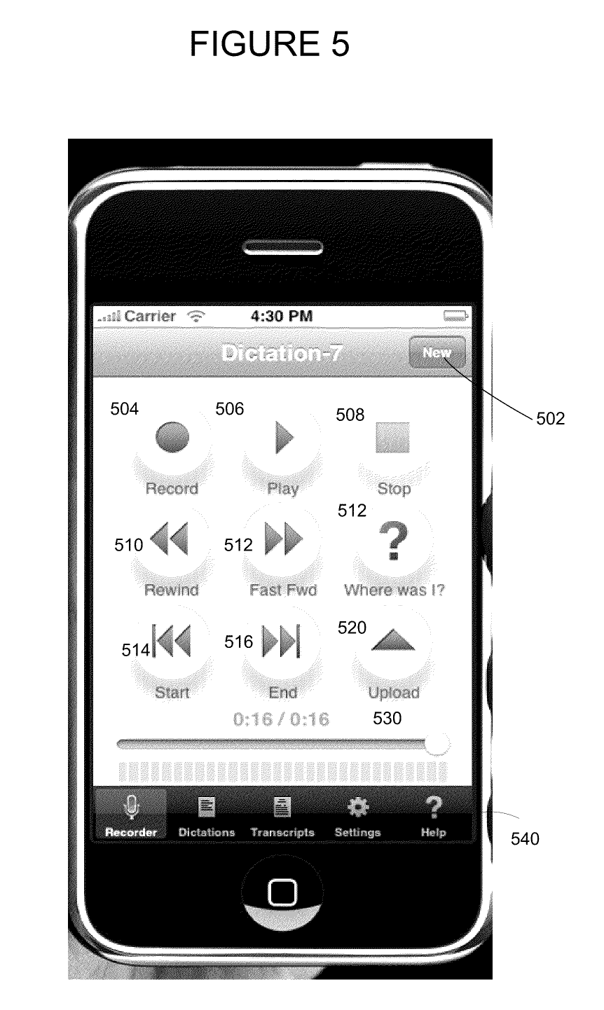

Referring now to FIGS. 5-10, different pages of the first graphical user interface are illustrated in screen shots illustrating how the dictation module could be implemented as in IPhone® application or other mobile device applications such as Android®.

FIG. 5 illustrates a recording mode for the dictation module. In one embodiment, the dictation module implements graphical user interface as shown in FIG. 5 upon entering the dictation application. As shown, the recording function interface includes a new option 502, a record option 504, a play option 506, a stop option 508, a rewind option 510, a fast forward option 512, a “where was I?” option 512, an option to go to the start of a recording 514, and end option 516 an upload option 520 and a slider bar 530.

In operation, in one embodiment, a default function instantiates a last dictation that was in progress. A user can choose to continue on the same dictation, choose a dictation form from a work list, for example, a list from the physician's schedule that is imported daily and available via a dictation tab. Alternatively, a user can start a new transcription by selecting the “New” button 502 on the upper left hand corner.

In an embodiment, the dictation module can assign automatically a default dictation name to new recordings.

The “Where Was I?” button 512 operates by determining a last recorded dictation if during the process of dictation a phone call is received. The dictation will be interrupted automatically. The user can then take the phone call. Once the phone call is complete, the user can return to the record screen. Upon being interrupted for some reason, one can press the “Where Was I” feature. This feature allows the user to playback the last few seconds of each recording so that they can pickup the recording where they left off prior to interruption. The numbers of seconds played back can be customized in the ‘Settings’ tab. The user can choose from 2 to 10 seconds at 2 second intervals.

After the dictation is completed, button 520 “upload” allows the user to upload the dictation to a website.

In one embodiment, some of the functionality of the buttons, such as fast forwarding and rewinding, locating a start and end of a dictation, can be done by the scroll bar 530 at the bottom.

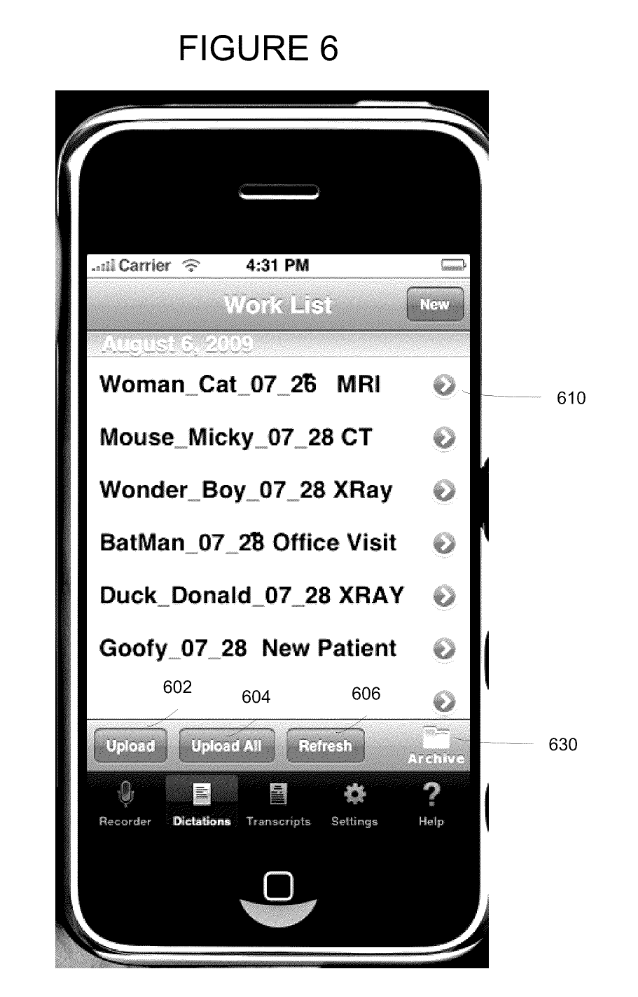

Referring to FIG. 6, a first graphical user interface can include an organization page for dictations. Dictations 610 can be organized as a work list that is an ongoing list. In one embodiment, the work list is a doctor's list of the patients that require a report. In an embodiment, the work list can be populated from a physician's daily schedule from a scheduling application. For example, a mobile device with a dictation module can interact with another application also present on the mobile device. The user can select a patient or other populated entity from this list and select a record tab and begin dictation.

The user is able to edit the name on each dictation if there is any discrepancy and save the changes to update the work list.

If the user does not have a list, they can simply press “New” on the recorder tab and dictate their reports. The application automatically gives a name to each new dictation serially e.g. Dictation 4, Dictation 5 etc. The user can also change the name of the dictation to actual patient names by selecting the arrow on the right side of the dictation name in the work list and editing.

In one embodiment, all current recordings are listed on the Dictations tab, and can be confirmed as current by selecting “refresh” 606. Once a user has completed dictation they can select one or multiple files for upload to a server by selecting “Upload” 602 or “Upload All” 604 buttons, respectively. Older recordings are available by selecting “archive” 630.

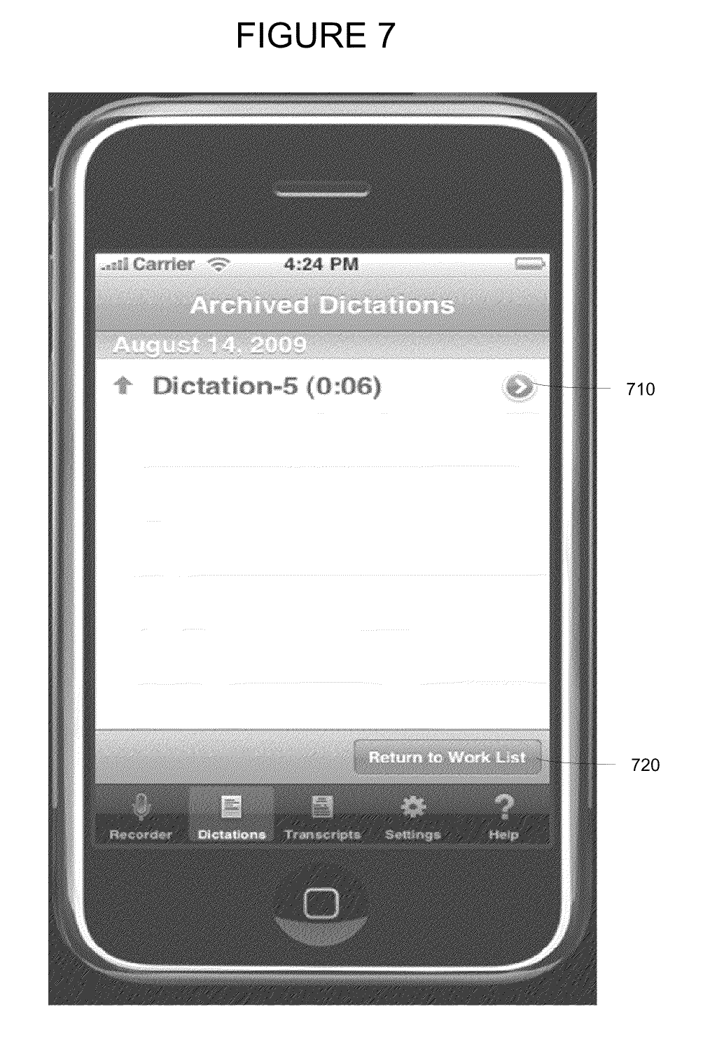

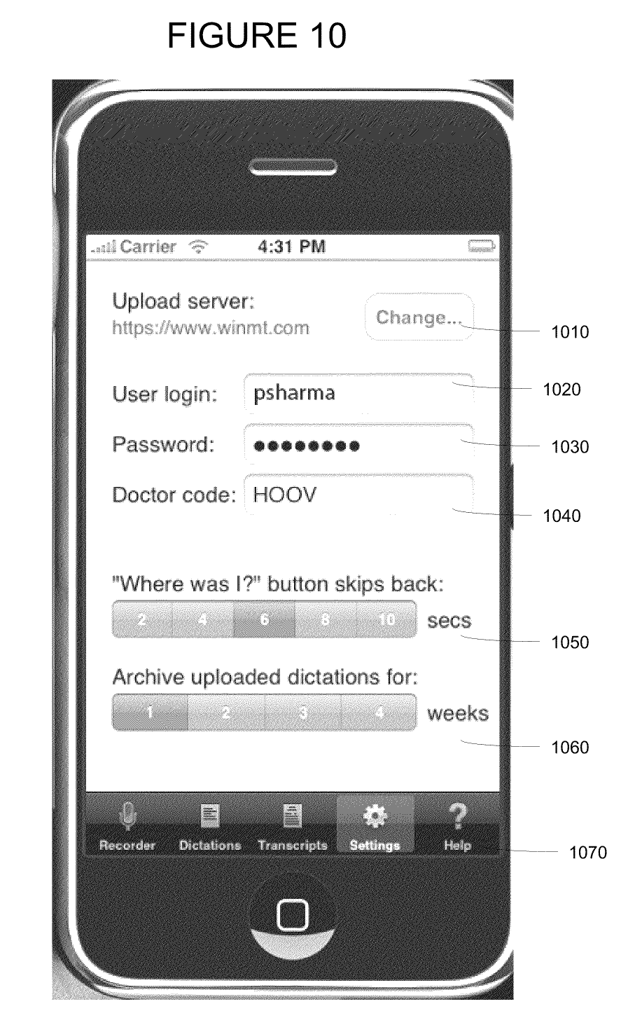

Referring to FIG. 7, the archived dictations page is illustrated showing prior saved recordings 710 and an option to return 720 to the previous page of the first graphical user interface. Once uploaded to a remote server, the files automatically move to the ‘Archive’ folder also located in the Dictations tab. A user can view the archive tab by selecting the “Archive” button at the right bottom corner of the screen. The files will stay in the Archives as long as the user has chosen for those to be there. This can be set up to 4 weeks by in the ‘Settings’ page described below with reference to FIG. 10. The user can toggle to the Archives via the Dictations tab and move archived dictations back to the dictation list to be re-uploaded if necessary.

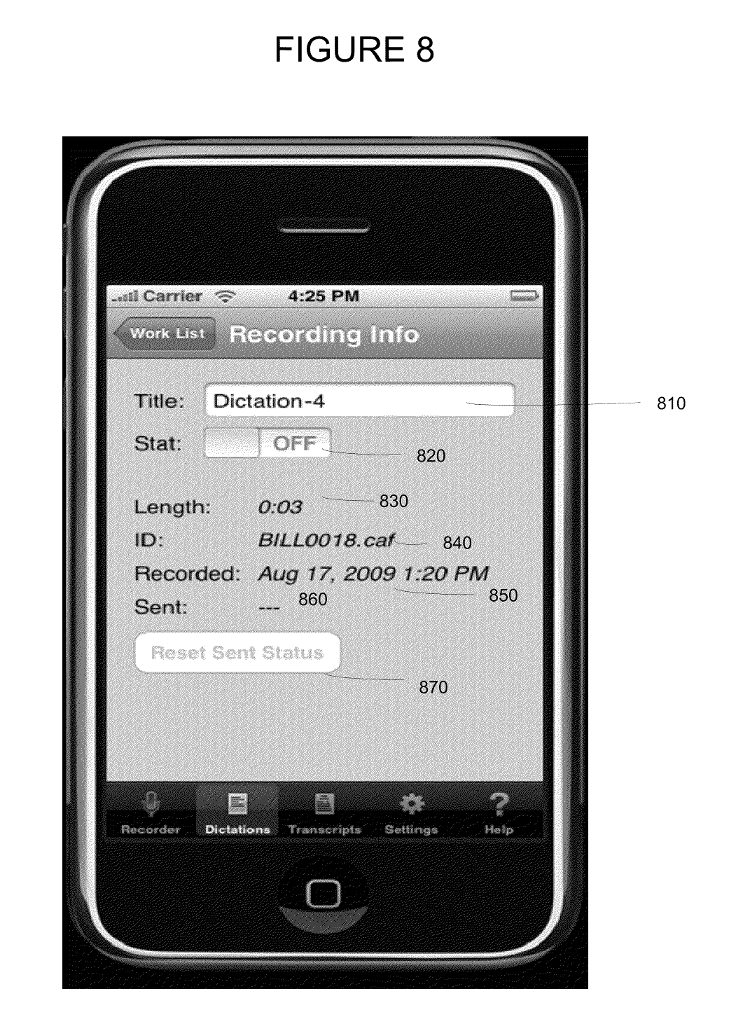

Referring now to FIG. 8, a recording information page is illustrated providing information relative to a particular recording. Information includes a title 810, an indication of whether the recording is considered important “Stat” 820, a length 830, “ID” 840, a date and time of the recording 850, a date and time that the recording was “sent” 860, and an option to “reset sent status” 870. In an embodiment, a user can select stat dictations which need to be completed quicker than the regular reports. The stat dictations can appear in Red color or other appropriate color for identification. The user can go back to the work list by selecting “Work List” in the upper left hand corner.

Referring now to FIG. 9, a transcriptions page of the first graphical user interface is shown including transcriptions 910. The transcriptions page allows a user to preview typed reports that have not been finalized or approved. For example, a user can review and approve reports that are ready to be finalized. In one embodiment, transcriptions can be edited by accessing either a website hosting a server with the transcription or by editing tools on the mobile device.

Referring now to FIG. 10, a settings page of the first graphical user interface is shown. As shown, the settings page allows a user to identify a server to which a user can upload voice files 1010, a user login name 1020, a password 1030, and a doctor code 1040.

In one embodiment, a transcribing entity, such as Infrahealth® supports receiving voice files, transcribing the files and returning transcribed files to the mobile device. For example, the user name and password could be assigned by the transcribing entity.

Doctor Code 1040 can include an individual code assigned to a physician to easily identify who each dictation belongs to so that the transcribing entity can transcribe and return the report to it's respective audio file, physician and medical facility.

Slide bar 1050 provides the number of seconds of playback when using the ‘Where Was I?’ feature.

Slide bar 1060 provides the number of weeks to store ‘Archive’ dictations (1-4 weeks). Archive uploaded dictation allows a user to select the number of weeks to store dictations on the mobile device, after which time the dictation will be deleted from the archive automatically.

Also shown in FIG. 10 is Help Tab 1070, which, in one embodiment, provides access to a user manual including an introduction, and explanations for getting started, the record tab, the dictation tab, the setting tab, and how to upload dictations.

Those with skill in the computing arts will recognize that the disclosed embodiments have relevance to a wide variety of applications and architectures in addition to those described above. In addition, the functionality of the subject matter of the present application can be implemented in software, hardware, or a combination of software and hardware. The hardware portion can be implemented using specialized logic; the software portion can be stored in a memory or recording medium and executed by a suitable instruction execution system such as a microprocessor.

While the subject matter of the application has been shown and described with reference to particular embodiments thereof, it will be understood by those skilled in the art that the foregoing and other changes in form and detail may be made therein without departing from the spirit and scope of the subject matter of the application, including but not limited to additional, less or modified elements and/or additional, less or modified blocks performed in the same or a different order.

Those having skill in the art will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in standard integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies equally regardless of the particular type of signal bearing media used to actually carry out the distribution. Examples of a recordable media include, but are not limited to, the following: recordable type media such as floppy disks, hard disk drives, CD ROMs, digital tape, and computer memory.

The herein described aspects depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Those skilled in the art will recognize that it is common within the art to implement devices and/or processes and/or systems in the fashion(s) set forth herein, and thereafter use engineering and/or business practices to integrate such implemented devices and/or processes and/or systems into more comprehensive devices and/or processes and/or systems. That is, at least a portion of the devices and/or processes and/or systems described herein can be integrated into comprehensive devices and/or processes and/or systems via a reasonable amount of experimentation. Those having skill in the art will recognize that examples of such comprehensive devices and/or processes and/or systems might include—as appropriate to context and application—all or part of devices and/or processes and/or systems of (a) an air conveyance (e.g., an airplane, rocket, hovercraft, helicopter, etc.), (b) a ground conveyance (e.g., a car, truck, locomotive, tank, armored personnel carrier, etc.), (c) a building (e.g., a home, warehouse, office, etc.), (d) an appliance (e.g., a refrigerator, a washing machine, a dryer, etc.), (d) a communications system (e.g., a networked system, a telephone system, a Voice over IP system, etc.), (e) a business entity (e.g., an Internet Service Provider (ISP) entity such as Comcast Cable, Quest, Southwestern Bell, etc.); a wired/wireless services entity such as Sprint, Cingular, Nextel, etc.), etc.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of this subject matter described herein. Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.).

We claim:

1. A method for integrating a communications system with a dictation system on a mobile device, the method comprising:
displaying a first graphical user interface screen on a display of the mobile device, the first graphical user interface screen including a first plurality of selections, when selected by a user, enable the user to dictate and create one or more voice files for sending to a receiving server; and
automatically displaying a second graphical user interface screen on the display of the mobile device when the communications system receives an incoming call, said second graphical user interface screen indicating suspension of dictation functionality and enabling telephone functionality.

2. The method of claim 1 wherein said first graphical user interface screen comprises a communication status display field, and a plurality of options enabling a recorder display, a transcription display and a dictation display.

3. The method of claim 1 wherein said second graphical user interface screen comprises at least one of a numeric field, a communication display field and a message display field.

4. The method of claim 1 wherein said second graphical user interface screen comprises a superimposed interface that provides one or more of a caller identification, a query to the user allowing the call to be accepted, a phone number of a party calling the user, or a default user interface associated with the mobile device.

5. The method of claim 1 wherein said first graphical user interface screen includes a “Where Was I?” button configured to determine a last recorded dictation if during the process of the last recorded dictation a phone call is received.

6. The method of claim 5 wherein the “Where Was I?” button enables a user to playback a customized amount of seconds of the last recorded dictation.

7. The method of claim 1 further comprising:
displaying a transcription page screen accessible via the first graphical user interface screen, the transcription page screen enabling user access to one or more transcriptions received from the receiving server, the transcriptions being text files associated with the one or more voice files.

8. The method of claim 1 wherein said first graphical user interface screen enables a user to access a recording information page, the recording information page allowing the user to identify one or more stat dictations which need to be queued for transcription ahead of non-stat dictations.

9. A computer readable medium having stored thereon sequences of instructions which are executable by a processor, and which, when executed by the processor, cause the processor to perform the steps of:
displaying a first graphical user interface screen on a display of the mobile device, the first graphical user interface screen including a first plurality of selections, when selected by a user, enable the user to dictate and create one or more voice files for sending to a receiving server; and
automatically displaying a second graphical user interface screen on the display of the mobile device when the communications system receives an incoming call, said second graphical user interface screen indicating suspension of dictation functionality and enabling telephone functionality.

10. A communication device comprising:
a processor;
audio input and output circuitry coupled to the processor;
a memory coupled to the processor; and
a dictation module coupled to the processor, the dictation module configured to implement a first graphical user interface screen on a display of the mobile device, the first graphical user interface screen including a first plurality of selections, when selected by a user, enable the user to dictate and create one or more voice files for sending to a receiving server; and
automatically implement a second graphical user interface screen on the display of the mobile device when the communications system receives an incoming call, said second graphical user interface screen indicating suspension of dictation functionality and enabling telephone functionality.

11. The communication device of claim 10 wherein the dictation module is coupled to the processor, located within the processor, and/or located in the memory.

12. The communication device of claim 10 wherein the memory is one or more of random access memory, read only memory, an optical memory, and/or a subscriber identity module memory.

13. The communication device of claim 10 wherein the audio input and output circuitry includes one or more of a microphone, a speaker, a transducer, and/or audio input and output circuitry.

14. The communication device of claim 10 further comprising:
a display coupled to the processor, the display being one or more of a liquid crystal display (LCD), a light emitting diode (LED) display, and/or a plasma display.

15. The communication device of claim 10 further comprising a housing coupled to the processor, the housing encasing the memory, the processor, and the audio input and output circuitry.

16. A network transcription system comprising:
a network controller;
a processor coupled to the network controller;
a memory coupled to the processor;
a receiver coupled to the processor; and
a dictation module coupled to the memory, the dictation module configured to implement a first graphical user interface screen on a display of the mobile device, the first graphical user interface screen including a first plurality of selections, when selected by a user, enable the sender to dictate and create one or more voice files for sending to a receiving server; and
automatically implement a second graphical user interface screen on the display of the mobile device when the communications system receives an incoming call, said second graphical user interface screen indicating suspension of dictation functionality and enabling telephone functionality.

17. The network system of claim 16 wherein the network controller is a controller for a data network, the data network being one or more of the Internet, an intranet, a local area network (LAN), a wide area network (WAN), a cable network, a telecommunications network, a local telephone network, a long distance telephone network, a cellular telephone network, a satellite communications network, and/or a cable television network.
